(19) United States
(12) Patent Application Publication
(10) Pub. No.: US 2014/0355115 A1
(43) Pub. Date: Dec. 4, 2014

(54) Dimming Device

(71) Applicant: BENQ MATERIALS CORPORATION, GUISHAN TOWNSHIP (TW)

(72) Inventors: Lung-Hai Wu, Taoyuan City (TW); Cyun-Tai Hong, New Taipei City (TW); Chun-Nan Shen, Luzhu Township (TW); Meng-Chieh Wu, New Taipei City (TW)

(73) Assignee: BENQ MATERIALS CORPORATION, GUISHAN TOWNSHIP (TW)

(21) Appl. No.: 14/290,365

(22) Filed: May 29, 2014

(30) Foreign Application Priority Data
May 30, 2013 (TW) 102119107

(51) Int. Cl. G02B 5/30

(52) U.S. Cl. CPC G02B 5/3083
USPC 359/489.07

(57) ABSTRACT

A dimming device includes a first polarizer, a second polarizer, a first retarder layer and a second retarder layer. The dimming device can generate full-light transmission state, dark state and a transitional state of various kinds of repeat patterns formed by a plurality of full-light transmission areas and dark areas.

### CROSS-REFERENCE TO RELATED APPLICATION

This application claims the benefit of Taiwan Patent Application No. 102119107, filed on May 30, 2013, in the Taiwan Intellectual Property Office, the disclosure of which is incorporated herein in its entirety by reference.

### BACKGROUND

1. Technical Field

The present invention relates to a dimming device for using in smart windows or window shades for generating various kinds of pattern composed of full-light transmission and dark areas.

2. Description of Related Art

In view of the demanding on aesthetics and functions for large windows, the requirements for different types of smart windows and window shades are increased. The light transmission of the current smart windows is controlled by electric field, it is required the electricity consumption.

In addition, the light transmission of the current smart windows can only switch between “on” state and “off” state, no transitional state is provided. Also, no pattern is generated by the light transmission when switching between the on state and off state.

The inventors of the present invention provide a dimming device which can provide full light transmission state, dark state and a transitional state with pattern composed of areas with full-light transmission state and areas with dark state by manually or motorizedly adjusting the relative positions of two sets of polarizers and retarders. No electricity is needed as required by the present smart window for controlling the alignment of the liquid crystal. Furthermore, the various pattern generated during the transitional state by adjusting the alignment of the areas with full light transmission state and the areas with dark state will provide an anti-peeping function, rather than the current smart windows provides only full light transmission state and dark state.

### SUMMARY OF THE INVENTION

Accordingly, the present disclosure is to provide a novel, inventive and useful dimming device.

An aspect of the present disclosure is to provide a dimming device comprising a first polarizer with a first absorption axis; a second polarizer with a second absorption axis, wherein the first absorption axis of the first polarizer is parallel to the second absorption axis of the second polarizer; a first retarder positioned between the first polarizer and the second polarizer and composed of a plurality of first optical-axis regions and a plurality of a second optical-axis regions, wherein the first optical-axis regions and the second optical-axis regions are alternatively arranged and adjacent to each other, and wherein the directions of the first optical-axis regions are at 45 degree to the direction of the first absorption axis and the directions of the second optical-axis regions are at −45 degree to the direction of the first absorption axis; and a second retarder positioned between the first retarder and the second polarizer and composed of a plurality of third optical-axis regions and a plurality of a fourth optical-axis regions, wherein the third optical-axis regions and the fourth optical-axis regions are alternatively arranged and adjacent to each other, and the directions of the first optical-axis regions are at 45 degree to the direction of the second absorption axis and the directions of the second optical-axis regions are at −45 degree to the direction of the second absorption axis; wherein the shapes, areas and the arrangement of the first optical-axis regions and the second optical-axis regions on the first retarder and the shapes, areas and the arrangement of the third optical-axis regions and the fourth optical-axis regions on the second retarder are the same.

Another aspect of the present disclosure is to provide a dimming device comprising a first polarizer with a first absorption axis; a second polarizer with a second absorption axis, wherein the first absorption axis of the first polarizer is perpendicular to the second absorption axis of the second polarizer; a first retarder positioned between the first polarizer and the second polarizer and composed of a plurality of first optical-axis regions and a plurality of a second optical-axis regions, wherein the first optical-axis regions and the second optical-axis regions are alternatively arranged and adjacent to each other, and wherein the directions of the first optical-axis regions are at 45 degree to the direction of the first absorption axis and the directions of the second optical-axis regions are at −45 degree to the direction of the first absorption axis; and a second retarder positioned between the first retarder and the second polarizer and composed of a plurality of third optical-axis regions and a plurality of a fourth optical-axis regions, wherein the third optical-axis regions and the fourth optical-axis regions are alternatively arranged and adjacent to each other, and the directions of the first optical-axis regions are at −45 degree to the direction of the second absorption axis and the directions of the second optical-axis regions are at 45 degree to the direction of the second absorption axis; wherein the shapes, areas and the arrangement of the first optical-axis regions and the second optical-axis regions on the first retarder and the shapes, areas and the arrangement of the third optical-axis regions and the fourth optical-axis regions on the second retarder are the same.

In a dimming device of a preferred embodiment of the present invention, the first polarizer and the second polarizer are selected from the group consisting to absorption-type polarizers, reflective polarizers, dyeing type polarizers, coatable polarizers, wire grid polarizers and a combination thereof.

In a dimming device of a preferred embodiment of the present invention, the first retarder and the second retarder are patterned retarders.

In a dimming device of a preferred embodiment of the present invention, the retardation values of the first retarder and the second retarder are ±λ/4.

In a dimming device of a preferred embodiment of the present invention, the first retarder is attached on the first polarizer and the second retarder is attached on the second polarizer.

In a dimming device of a preferred embodiment of the present invention, the present dimming device further comprises a first adhesive layer between the first retarder and the first polarizer for attaching the first retarder and the first polarizer, and a second adhesive layer between the second retarder and the second polarizer for attaching the second retarder and the second polarizer.

In a dimming device of a preferred embodiment of the present invention, the present dimming device further comprises a horizontal moving device and a vertical moving device connecting to one of the first retarder and the second retarder for relatively moving the first retarder and the second retarder horizontally or vertically.

In a dimming device of a preferred embodiment of the present invention, the present dimming device further comprises a horizontal moving device and a vertical moving device connecting respectively to both of the first retarder and the second retarder for relatively moving the first retarder and the second retarder horizontally or vertically.

In a dimming device of a preferred embodiment of the present invention, the present dimming device further comprises a horizontal moving device and a vertical moving device connecting to one of the first polarizer and the second polarizer for relatively moving the first retarder and the second retarder horizontally and vertically.

In a dimming device of a preferred embodiment of the present invention, the present dimming device further comprises a vertical moving device and a horizontal moving device connecting respectively to both of the first polarizer and the second polarizer for relatively moving the first retarder and the second retarder vertically and horizontally.

In a dimming device of a preferred embodiment of the present invention, the present dimming device further comprises a functional layer on one side of the dimming device, wherein the functional layer is selected from the group consisting of a thermal insulation layer, an antilock layer, a hard coating layer, an antifouling layer, a brightness enhancement layer and a combination thereof.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIGS. 1a and 1b are diagrams illustrating the principle of a light passing through a set of polarizers and retarders;

FIG. 2 is a perspective view of the dimming device of a preferred embodiment of the present invention;

FIGS. 3a to 3b are perspective views illustrating a dimming device generating a full-light transmission state and dark state of a preferred embodiment of the present invention;

FIGS. 3c to 3d are perspective views illustrating a dimming device generating a transitional state with a pattern composed of areas with full-light transmission state and areas with dark state of a preferred embodiment of the present invention;

FIGS. 4a to 4b are perspective views illustrating the optical axes of retarders in a dimming device of a preferred embodiment of the present invention;

FIGS. 5a to 5b are perspective views illustrating the optical axes of retarders in a dimming device of another preferred embodiment of the present invention;

FIGS. 6a to 6b are perspective views illustrating the optical axes of retarders in a dimming device of a still another preferred embodiment of the present invention;

FIG. 7 is a perspective view illustrating a dimming device of a further preferred embodiment of the present invention;

FIGS. 8a to 8b are perspective views illustrating a vertical moving device and a horizontal moving device connecting a dimming device of a preferred embodiment of the present invention; and

FIGS. 9a to 9b are perspective views illustrating a vertical moving device and a horizontal moving device connecting a dimming device of another preferred embodiment of the present invention.

### DETAILED DESCRIPTION OF EMBODIMENTS OF THE INVENTION

To describe the technical features of the present invention in greater detail, preferred embodiments of the present invention are provided below along with the accompanied drawings accordingly as follows. The various embodiments will be described in detail with reference to the accompanying drawings. References made to particular examples and implementations are for illustrative purposes, and are not intended to limit the scope of the invention or the claims.

The dimming device of the present invention will be described along with the accompanied drawings accordingly as follows. It is appreciated that the same reference numbers will be used throughout the drawings to refer to the same or like parts.

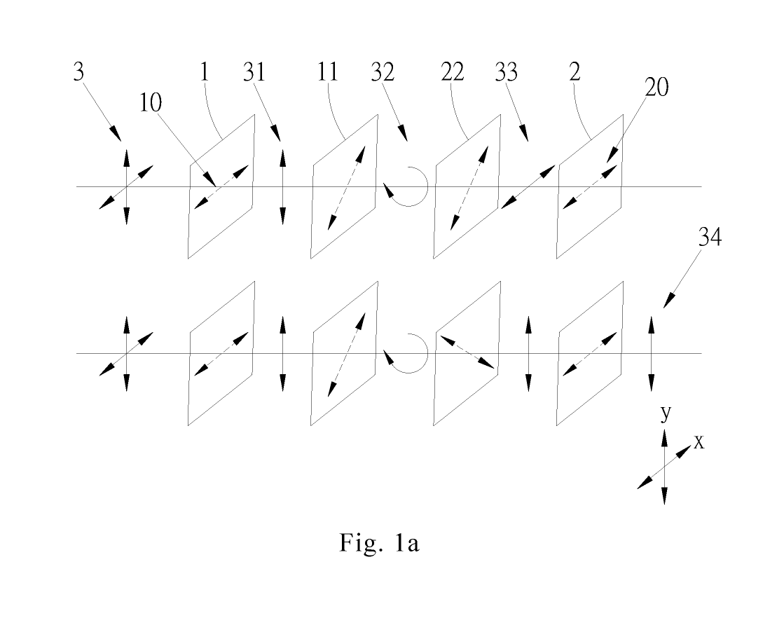

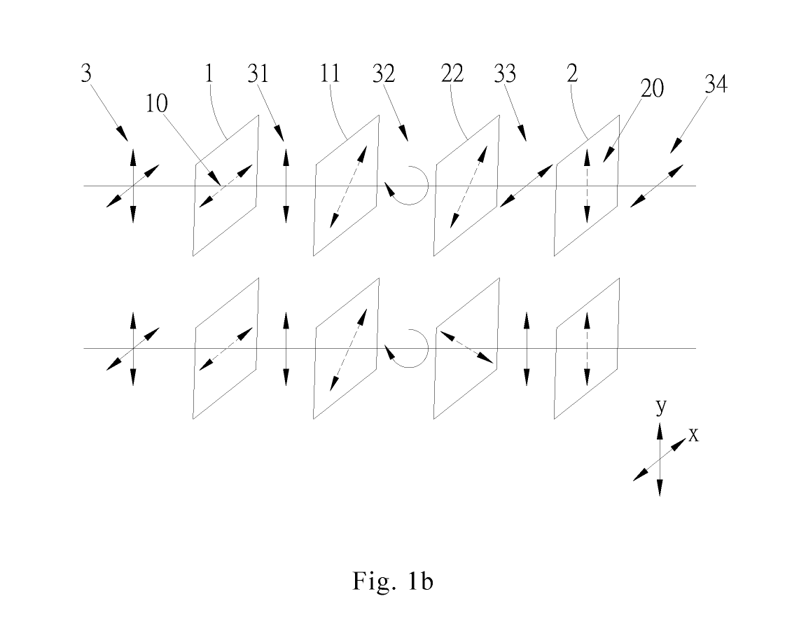

FIGS. 1a and 1b show a diagram illustrating the principle of a light travelling through two polarizers 1, 2 and two retarders 11, 22 to generate a full-light transmission state and a dark state. According to FIG. 1a, when the first absorption axis 10 of the first polarizer 1 and the second absorption axis 20 of the second polarizer 2 are parallel to each other, the light 3 travels through the first polarizer 1 to change to a first linearly polarized light 31 in Y-axis. The first linearly polarized light 31 then travels toward to the first retarder 11, the optical axis of which is at 45 degree to the first absorption axis 10 of the first polarizer 1, the first linearly polarized light 31 is converted to a circularly polarized light 32. The circularly polarized light 32 further travels through the second retarder 22, the optical axis of which is the same as that of the first retarder 11, the circularly polarized light 32 is converted to a second linearly polarized light 33 in X-axis direction. The second linearly polarized light 33 further travels through a second polarizer 2 with the second absorption axis 20 in X-axis direction and then is absorbed by the second polarizer 2. Thus, the light cannot transmit through the polarizers and retarders so as to generate a dark state. In another case, when the optical axis of the second retarder 22 is at 90 degrees to the optical axis of the first retarder 11, the polarization direction of the second linearly light 33 is converted into Y-axis direction. Thus, the light can travel through the second polarizer 2, and is converted into a third linearly polarized light 34 to generate a light transmission state. Referring to FIG. 1b, when the first absorption axis 10 of the first polarizer 1 and the second absorption axis 20 of the second polarizer 2 are perpendicular to each other, the light 3 travels through the first polarizer 1 to change to a first linearly polarized light 31 in Y-axis. The first linearly polarized light 31 then travels toward to the first retarder 11, the optical axis of which is at 45 degree to the first absorption axis 10 of the first polarizer 1, the first linearly polarized light 31 is converted to a circularly polarized light 32. The circularly polarized light 32 further travels through the second retarder 22, the optical axis of which is the same as that of the first retarder 11, the circularly polarized light 32 is converted to a second linearly polarized light 33 in X-axis direction. The second linearly polarized light 33 further travels through a second polarizer 2 with an absorption axis in Y-axis direction and is converted into a third linearly polarized light 34. Thus, the light can transmit through the polarizers and retarders to generate a full-light transmission state. Furthermore, when the optical axis of the second retarder 22 is at 90 degrees to the optical axis of the first retarder 11, the polarization direction of the second linearly polarized light 33 will be converted into Y-axis direction and then is absorbed by the second polarizer 2, the absorption axis of which is in the direction of Y-axis, so that the light is unable to travel through, a dark state is generated accordingly.

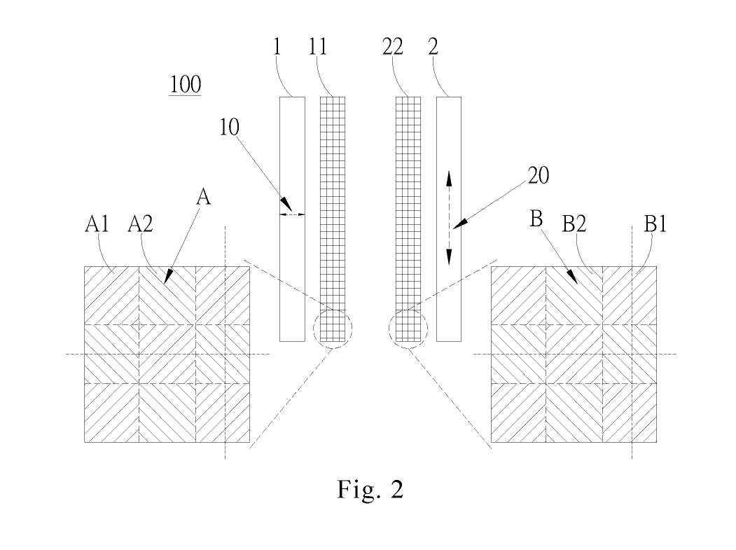

Referring to FIG. 2, in a preferred embodiment of the present invention, the dimming device 100 comprises a first polarizer 1 with a first absorption axis 10, a second polarizer 2 with a second absorption axis 20, a first retarder 11 positioned between the first polarizer 1 and the second polarizer 2, and a second retarder 22 positioned between the first retarder 11 and the second polarizer 2. The first retarder 11 comprises a plurality of regions A composed of a first optical-axis region A1 at +45 degrees and a second optical-axis region A2 at −45 degrees respectively to the first absorption axis 10 of the first polarizer 1 and at least an axis in the first retarder 11 extended in a direction perpendicular to or parallel to the first absorption axis 10 will pass through a first optical-axis region A1 and a second optical-axis region A2. The second retarder 22 comprises a plurality of regions B composed of a third optical-axis region B1 at −45 degrees and a fourth optical-axis region B2 at +45 degrees respectively to the second absorption axis 20 of the second polarizer 2 and at least an axis in the second retarder 22 extended in a direction perpendicular to or parallel to the second absorption axis 20 will pass through a third optical-axis region B1 and a fourth optical-axis region B2. Therefore, when the first retarder 11 and the second retarder 22 are relatively moved to each other in opposite direction either perpendicular to or parallel to the absorption axis of the polarizers, the dimming device 100 will generate a transitional-state pattern composed of full-light transmission areas and dark areas. The shapes, areas and the arrangement of the first optical-axis regions A1 and the second optical-axis regions A2 on the first retarder 11 and the shapes, areas and the arrangement of the third optical-axis regions B1 and the fourth optical-axis regions B2 on the second retarder 22 are the same. When the optical axes of the first optical-axis regions A1 and the second optical-axis regions A2 of the first regions A are respectively perpendicular to or parallel to the corresponding optical axes of the third optical-axis regions B1 and the fourth optical-axis regions B2 of the regions B, the dimming device 100 will generate dark state and full-light transmission state accordingly.

The retarder with a plurality of regions having different optical axis arrangement can be manufactured by, such as, the embossing method for manufacturing a patterned retarder film using in a stereoscopic display. The embossing method for manufacturing a patterned retarder film comprises engraving the surface of a roller for a patterned alignment micro-structure, embossing a film to form the patterned alignment micro-structures thereon, coating and curing a layer of liquid crystal on the film. Accordingly, a patterned retarder composed of areas with different optical axes can be manufactured.

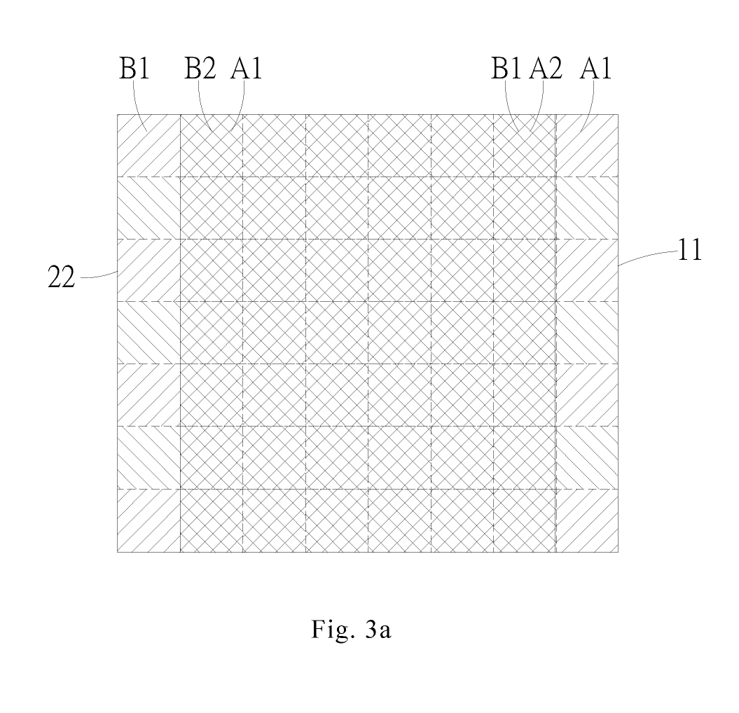

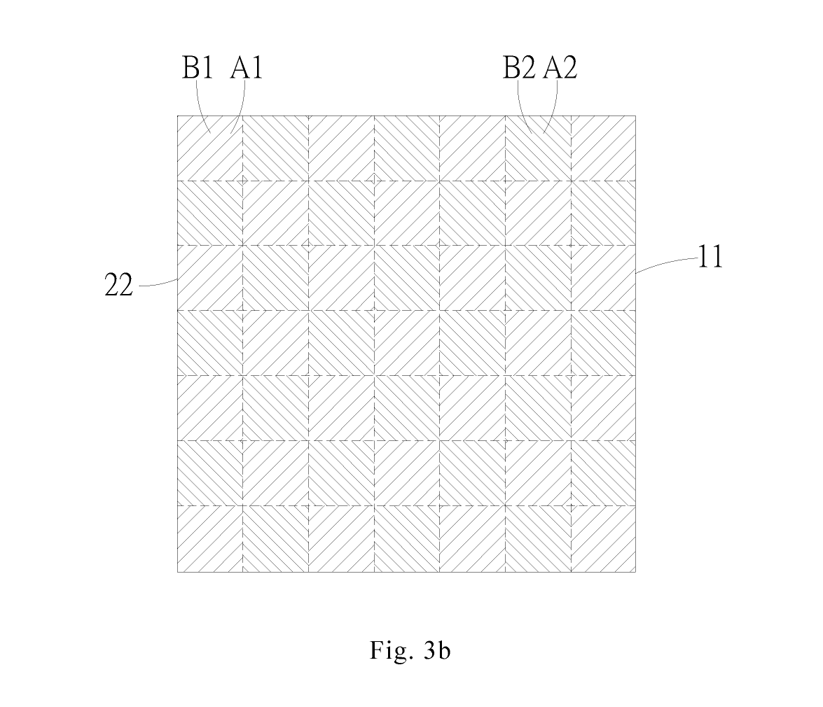

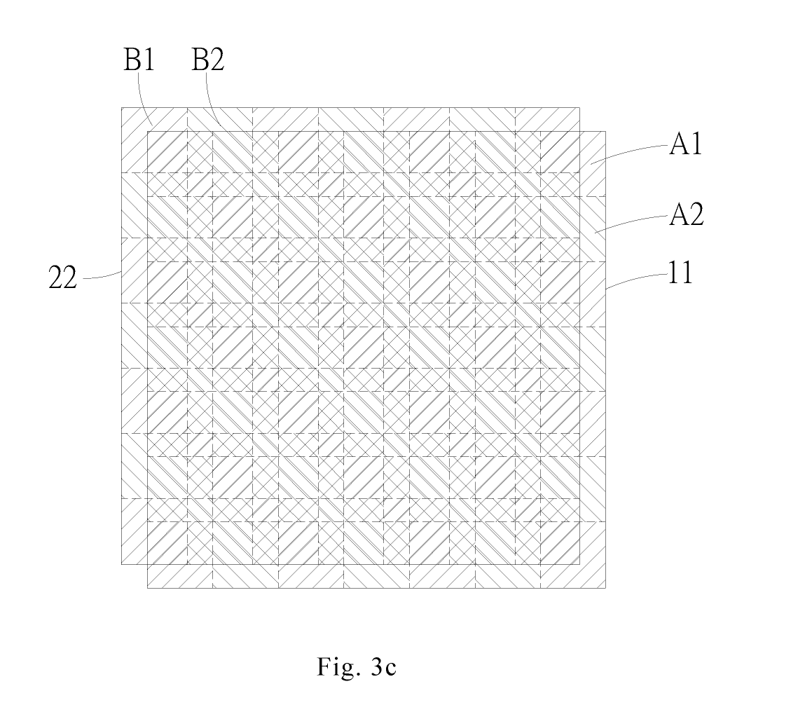

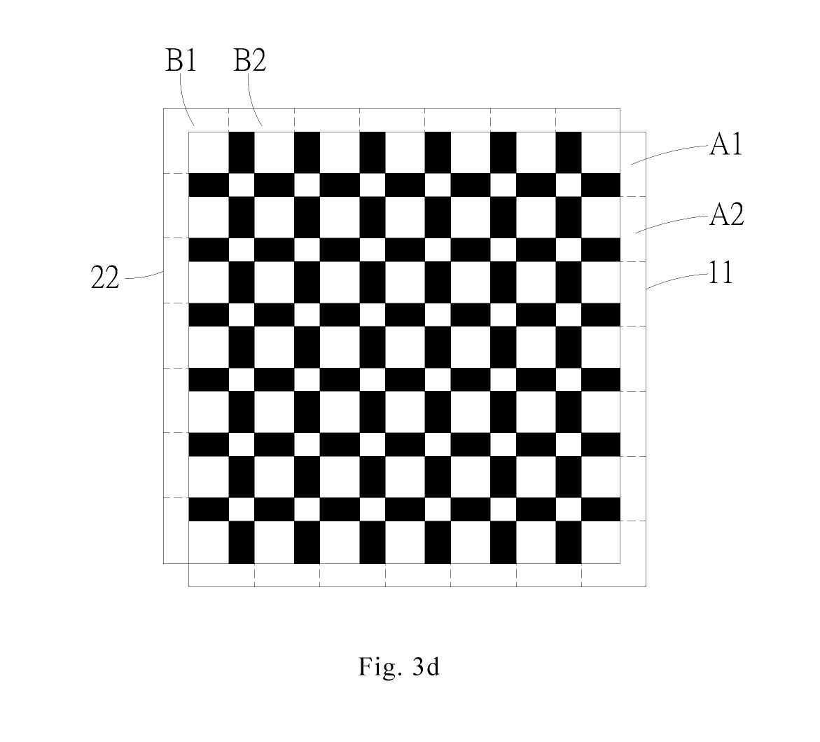

Using the light polarization principle described in FIGS. 1a and 1b, the dimming device 100 of the present invention can exhibit a full-light transmission state, a dark state, and a transitional state. Referring to FIGS. 3a, 3b and 3c, those show the relative movement of the first retarder 11 and the second retarder 22 of the present dimming device. In this embodiment, for simplifying the illustration, the first optical-axis regions A1 and the second optical-axis regions A2 of the first retarder 11 and the third optical-axis regions B1 and the fourth optical-axis regions B2 of the second retarder 22 are all in squares of same size. As shown in FIG. 3a, when the first retarder 11 and the second retarder 22 are relatively moved in opposition direction for distance the same as the width of an individual square of the first optical-axis regions A1, the first optical-axis regions A1 of the first retarder 11 are overlapped with the fourth optical-axis regions B2 of the second retarder 22 and the second optical-axis regions A2 of the first retarder 11 are overlapped with the third optical-axis regions B1 of the second retarder 22. In such a case, the optical axis of the first optical-axis regions A1 and the second optical-axis regions A2 of the first retarder 11 are perpendicular to those of the third optical-axis regions B1 and the fourth optical-axis regions B2 of the second retarder 22. Therefore, the dimming device 100 exhibits a dark state. In FIG. 3b, when the first retarder 11 and the second retarder 22 are relatively moved in opposition direction to completely overlap with each other, the optical axis of the first optical-axis regions A1 and the second optical-axis regions A2 of the first retarder 11 are parallel to those of the third optical-axis regions B1 and the fourth optical-axis regions B2 of the second retarder 22. In such a case, the dimming device 100 exhibits a full-light transmission state. Another embodiment as shown in FIG. 3c, when the first retarder 11 and the second retarder 22 are relatively moved in both vertical and horizontal directions respectively for a distance not equal to the width of an individual square of the optical optical-axis regions A1 and/or not equal to an integer multiple thereof, the first optical-axis regions A1 of the first retarder 11 are partly overlapped with the fourth optical-axis regions B2 of the second retarder 22 and the second optical-axis regions A2 of the first retarder 11 are partly overlapped with the third optical-axis regions B1 of the second retarder 22. In such a case, the optical axis of the first optical-axis regions A1 and the second optical-axis regions A2 of the first retarder 11 are partly parallel to and/or partly perpendicular to those of the third optical-axis regions B1 and the fourth optical-axis regions B2 of the second retarder 22. Therefore, the dimming device 100 exhibits a transitional state with a repeated pattern of full-light transmission and dark states. Accordingly, the dimming device 100 can exhibit various states by adjusting the relative movement of the first retarder 11 and second retarder 22. Furthermore, referring to FIG. 3d, it shows a perspective view of another embodiment of the present dimming device 100 exhibiting a transitional state. When using the dimming device 100 of the present embodiment, the dimming device can exhibit various pattern composed with a plurality of squares of different sizes with full-light transmission state and dark state. Therefore, the present dimming device can use for anti-peeping.

According to a dimming device of the present invention, the first absorption axis 10 of the first polarizer 1 can be perpendicular to or parallel to the second absorption axis 20 of the second polarizer 2. In an embodiment of the present invention that the first absorption axis 10 of the first polarizer 1 is perpendicular to the second absorption axis 20 of the second polarizer 2, if the optical-axis of the first retarder 11 is perpendicular to the optical axis of the second retarder 22, the dimming device 100 is light non-transmissible; if the optical axis of the first retarder 11 is parallel to the optical axis of the second retarder 22, the dimming device 100 is light transmissible. In another embodiment of the present invention, the first absorption axis 10 of the first polarizer 1 is parallel to the second absorption axis 20 of the second polarizer 2, if the optical-axis of the first retarder 11 is perpendicular to the optical axis of the second retarder 22, the dimming device 100 is light transmissible; if the optical axis of the first retarder 11 is parallel to the optical axis of the second retarder 22, the dimming device 100 is light non-transmissible.

In a dimming device of another one embodiment of the present invention, the first polarizer 1 and the second polarizer 2 can be absorption-type polarizers or reflective polarizers. In the embodiment of a dimming device 100 of the present invention using an absorption-type polarizer, when the dimming device 100 is light non-transmissible, the light transmitted therethrough is absorbed by the absorption-type polarizer. In the embodiment of a dimming device 100 of the present invention using a reflective polarizer, when the dimming device 100 is light non-transmissible, the light transmitted therethrough is reflected by the reflective polarizer to show a mirror function. Furthermore, the first polarizer 1 and the second polarizer 2 can be dyeing type polarizers, coatable polarizers, wire grid polarizers and a combination thereof.

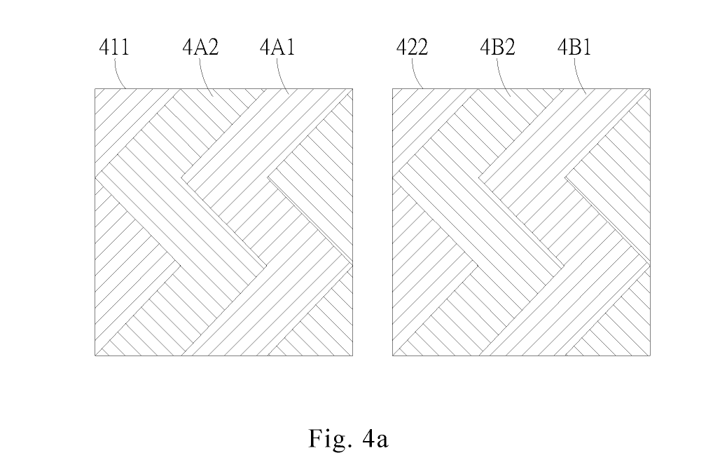

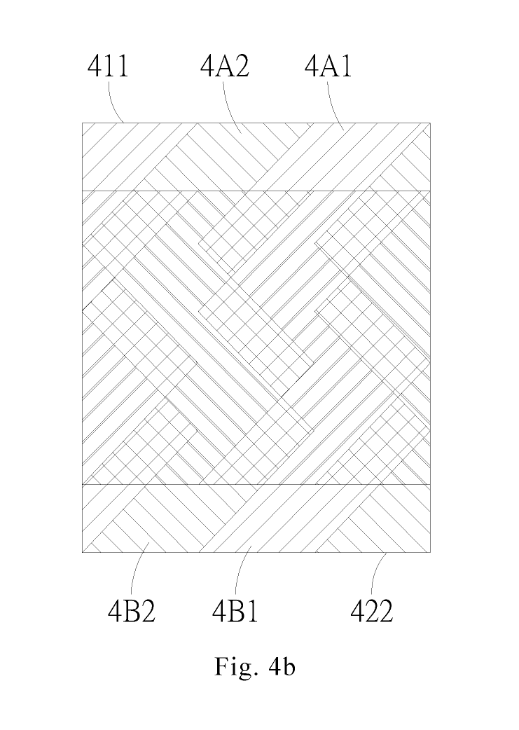

FIGS. 4a and 4b show a first retarder and a second retarder with corresponding pattern used a dimming device of another embodiment of the present invention. In FIG. 4a, the first retarder 411 comprises a plurality of first optical-axis regions 4A1 and a plurality of second optical-axis regions 4A2. The second retarder 422 comprises a plurality of third optical-axis regions 4B1 and a plurality of fourth optical-axis regions 4B2. When the first retarder 411 and the second retarder 422 are relatively moved in opposite directions, the first optical-axis regions 4A1 are overlapped with the third optical-axis regions 4B1 and the second optical-axis regions 4A2 are overlapped with the fourth optical-axis regions 4B2. In this case, the optical axes of the first optical-axis regions 4A1 and the second optical-axis regions 4A2 are parallel to those of the third optical-axis regions 4B1 and the fourth optical-axis regions 4B2, and thus, the dimming device will exhibit full-light transmission state or dark state. When the first retarder 411 and the second retarder 422 are relatively being moved in vertical opposite directions for partly overlapping each other, as shown in FIG. 4b, the present dimming device will exhibit a transitional state with various pattern composed with regions of full-light transmission state and regions of dark state because the optical axes of the first optical-axis regions 4A1 and the second optical-axis regions 4A2 are alternatively changeably parallel to or perpendicular to the optical axes of the third optical-axis regions 4B1 and the fourth optical-axis regions 4B2 during the movement.

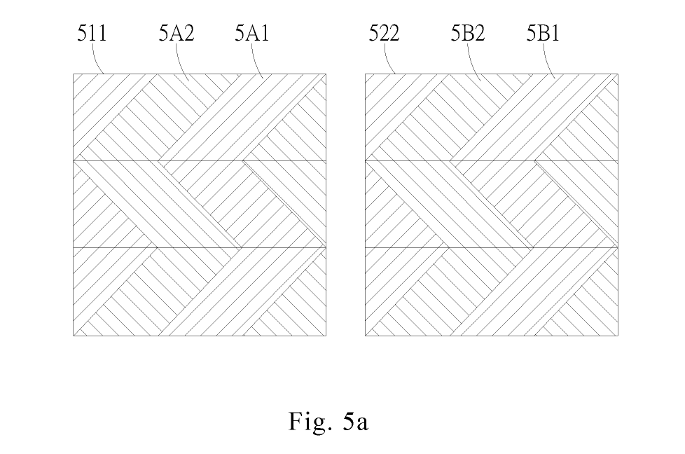

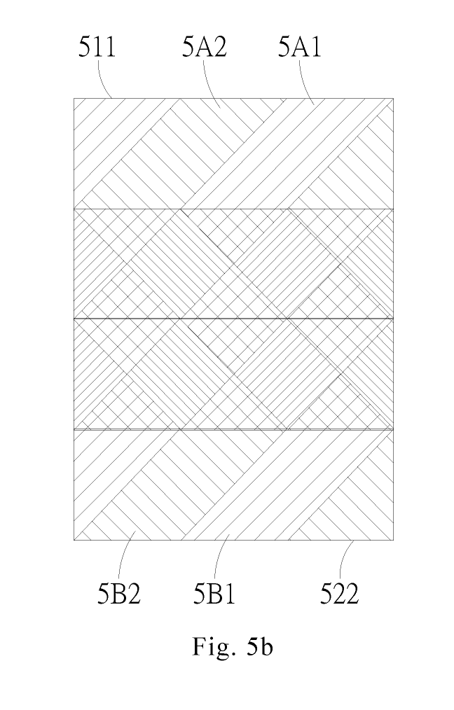

FIGS. 5a and 5b show a dimming device of a further embodiment of the present invention, in which only the first retarder and the second retarder are shown for brief illustration. In FIG. 5a, the first retarder 511 comprises a plurality of first optical-axis regions 5A1 and a plurality of second optical-axis regions 5A2. The second retarder 522 comprises a plurality of third optical-axis regions 5B1 and a plurality of fourth optical-axis regions 5B2. When the first retarder 511 and the second retarder 522 are relatively moved in opposite directions, the first optical-axis regions 5A1 are overlapped with the third optical-axis regions 5B1 and the second optical-axis regions 5A2 are overlapped with the fourth optical-axis regions 5B2. In this case, the optical axes of the first optical-axis regions 5A1 and the second optical-axis regions 5A2 are parallel to those of the third optical-axis regions 5B1 and the fourth optical-axis regions 5B2, and thus, the dimming device will exhibit full-light transmission state or dark state. When the first retarder 411 and the second retarder 422 are relatively being moved in vertical opposite directions for partly overlapping each other, as shown in FIG. 5b, the present dimming device will exhibit a transitional state with various pattern composed with regions of full-light transmission state and regions of dark state because the optical axes of the first optical-axis regions 5A1 and the second optical-axis regions 5A2 are alternatively changeably parallel to or perpendicular to the optical axes of the third optical-axis regions 5B1 and the fourth optical-axis regions 5B2 during the movement.

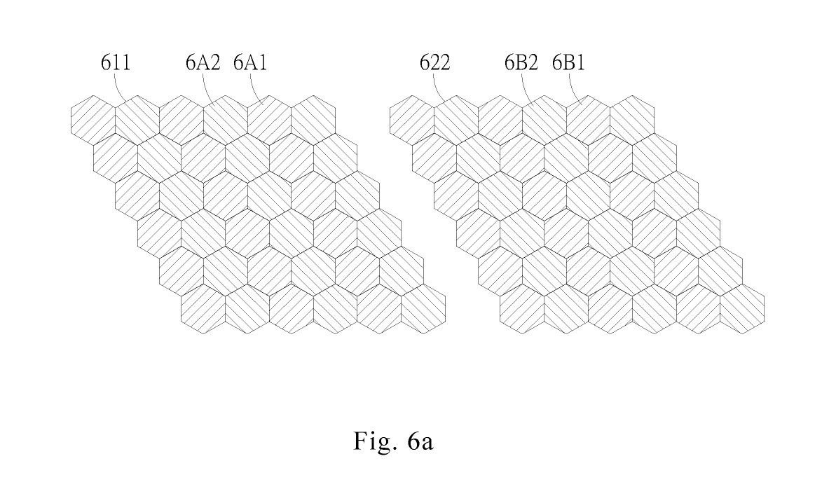

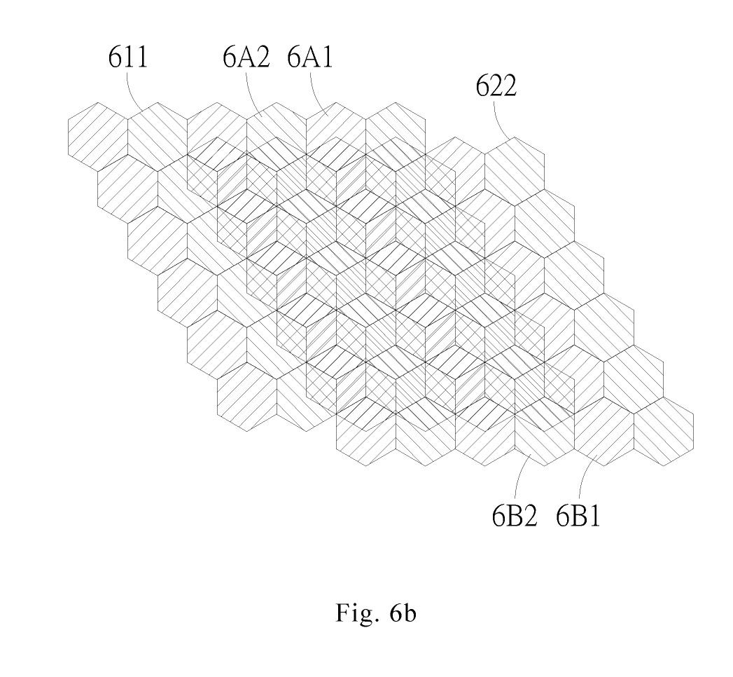

FIGS. 6a and 6b show a dimming device of a further embodiment of the present invention, in which only the first retarder and the second retarder are shown for brief illustration. In FIG. 6a, the first retarder 611 comprises a plurality of first optical-axis regions 6A1 and a plurality of second optical-axis regions 6A2. The second retarder 622 comprises a plurality of third optical-axis regions 6B1 and a plurality of fourth optical-axis regions 6B2. When the first retarder 611 and the second retarder 622 are relatively moved in opposite directions, the first optical-axis regions 6A1 are overlapped with the third optical-axis regions 6B1 and the second optical-axis regions 6A2 are overlapped with the fourth optical-axis regions 6B2. In this case, the optical axes of the first optical-axis regions 6A1 and the second optical-axis regions 6A2 are parallel to those of the third optical-axis regions 6B1 and the fourth optical-axis regions 6B2, and thus, the dimming device will exhibit full-light transmission state or dark state. When the first retarder 611 and the second retarder 622 are relatively being moved in vertical opposite directions for partly overlapping each other, as shown in FIG. 6b, the present dimming device will exhibit a transitional state with various pattern composed with regions of full-light transmission state and regions of dark state because the optical axes of the first optical-axis regions 6A1 and the second optical-axis regions 6A2 are alternatively changeably parallel to or perpendicular to the optical axes of the third optical-axis regions 6B1 and the fourth optical-axis regions 6B2 during the movement.

In a dimming device of a preferred embodiment of the present invention, the first retarder and the second retarder are patterned retarders comprising a plurality of regions with various optical axes.

In a dimming device of another preferred embodiment of the present invention, the retardation of the first retarder and the second retarder are ±λ/4 in order for light alternatively changed in linear polarization and circular polarization.

In a dimming device of another preferred embodiment of the present invention, the retardation of the first retarder and the second retarder can be attached on the first polarizer and the second polarizer respectively.

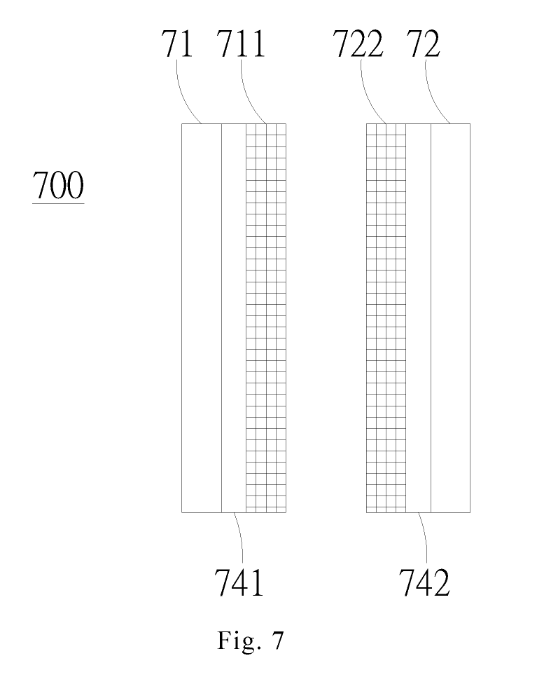

FIG. 7 shows a dimming device 700 of a further preferred embodiment of the present invention. The present dimming device comprises a first adhesive layer 741 between the first polarizer 71 and the first retarder 711 for adhering the first polarizer 71 and the first retarder 711 and a second adhesive layer 742 between the second polarizer 72 and the second retarder 722 for adhering the second polarizer 72 and the second retarder 722.

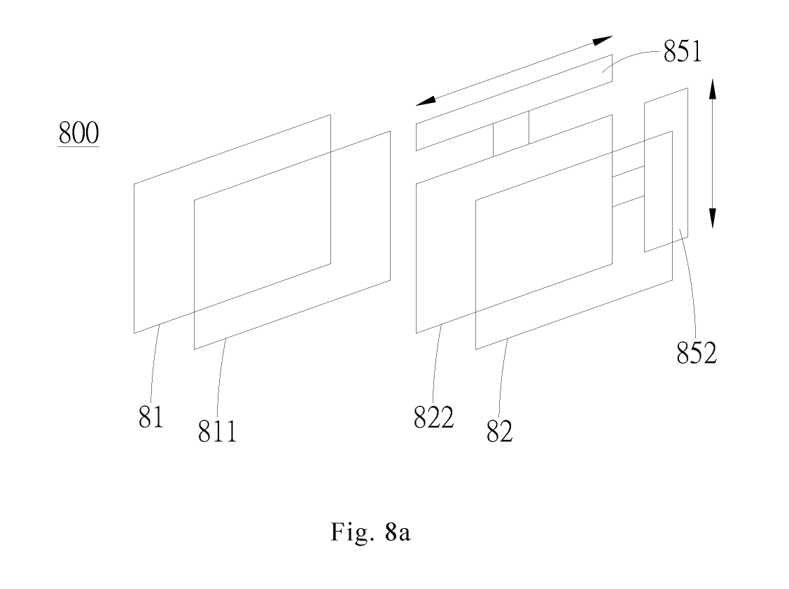

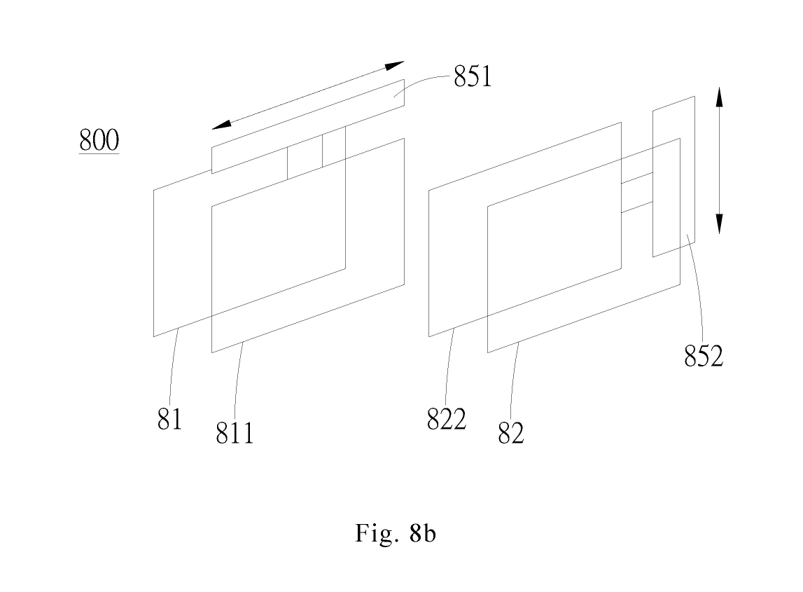

FIG. 8a shows a dimming device 800 of another preferred embodiment of the present invention. The present dimming device further comprises a horizontal movement device 851 and a vertical movement device 852 coupled to the first retarder 811 for horizontally and/or vertically moving the first retarder 811 in relative to the second retarder 822. In this case, while the first polarizer 81 and the second polarizer 82 are stationary, the dimming device will generate full-light transmissible state and dark state. Also, the horizontal movement device 851 and a vertical movement device 852 can be coupled to the second retarder 822.

FIG. 8b shows a dimming device 800 of further another preferred embodiment of the present invention. The present dimming device further comprises a horizontal movement device 851 and a vertical movement device 852 respectively coupled to both of the first retarder 811 and the second retarder 822 for horizontally and vertically moving the first retarder 811 and the second retarder 822, respectively. In this case, while the first polarizer 81 and the second polarizer 82 are stationary, the dimming device will generate full-light transmissible state and dark state.

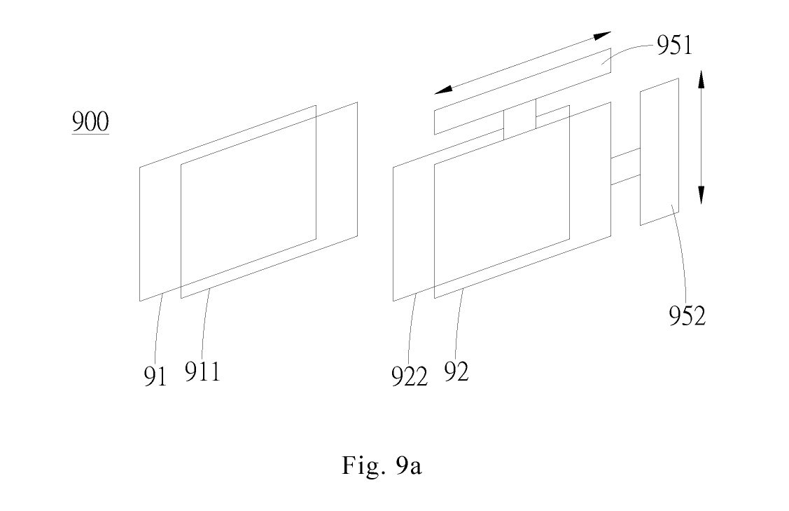

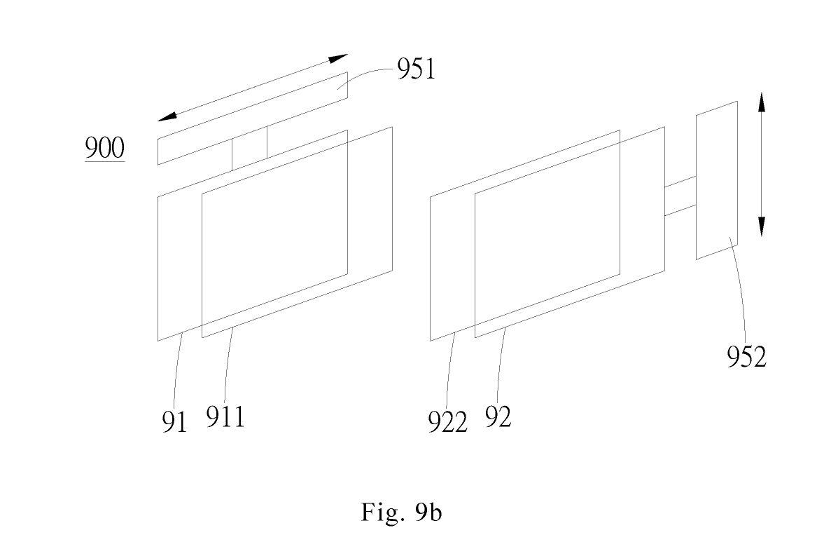

FIG. 9a shows a dimming device 900 of further another preferred embodiment of the present invention. When the first retarder 911 and the second retarder 922 are adhered to the first polarizer 91 and the second polarizer 92 respectively, the dimming device can further comprise a horizontal movement device 951 and a vertical movement device 952 coupled to the second polarizer 92 so as to horizontally and/or vertically move the second retarder 922 in relative to the first retarder 911. Also, the horizontal movement device 951 and a vertical movement device 952 can be coupled to the first polarizer 91.

FIG. 9b shows a dimming device 900 of further another preferred embodiment of the present invention. When the first retarder 911 and the second retarder 922 are adhered to the first polarizer 91 and the second polarizer 92 respectively, the dimming device can further comprise a horizontal movement device 951 and a vertical movement device 952 coupled to both of the first polarizer 91 and the second polarizer 92 respectively so as to horizontally and vertically move the first retarder 911 and the second retarder 922 respectively.

A dimming device of still another one preferred embodiment of the present invention, the dimming device further comprises a functional layer on one side thereof, wherein the functional layer is selected from the group consisting of a thermal insulation layer, an antilock layer, a hard coating layer, an antifouling layer, a brightness enhancement layer and a combination thereof.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A dimming device comprising:
a first polarizer with a first absorption axis;
a second polarizer with a second absorption axis, wherein the first absorption axis of the first polarizer is parallel to the second absorption axis of the second polarizer;
a first retarder positioned between the first polarizer and the second polarizer and composed of a plurality of first optical-axis regions and a plurality of a second optical-axis regions, wherein the first optical-axis regions and the second optical-axis regions are alternatively arranged and adjacent to each other, and wherein directions of the first optical-axis regions are at 45 degree to a direction of the first absorption axis and directions of the second optical-axis regions are at −45 degree to the direction of the first absorption axis; and
a second retarder positioned between the first retarder and the second polarizer and composed of a plurality of third optical-axis regions and a plurality of a fourth optical-axis regions, wherein the third optical-axis regions and the fourth optical-axis regions are alternatively arranged and adjacent to each other, and wherein directions of the third optical-axis regions are at 45 degree to a direction of the second absorption axis and directions of the fourth optical-axis regions are at −45 degree to the direction of the second absorption axis;
wherein shapes, areas and arrangement of the first optical-axis regions and the second optical-axis regions on the first retarder and shapes, areas and arrangement of the third optical-axis regions and the fourth optical-axis regions on the second retarder are the same.

2. A dimming device comprising:
a first polarizer with a first absorption axis;
a second polarizer with a second absorption axis, wherein the first absorption axis of the first polarizer is perpendicular to the second absorption axis of the second polarizer;
a first retarder positioned between the first polarizer and the second polarizer and composed of a plurality of first optical-axis regions and a plurality of a second optical-axis regions, wherein the first optical-axis regions and the second optical-axis regions are alternatively arranged and adjacent to each other, and wherein directions of the first optical-axis regions are at 45 degree to direction of the first absorption axis and directions of the second optical-axis regions are at −45 degree to the direction of the first absorption axis; and
a second retarder positioned between the first retarder and the second polarizer and composed of a plurality of third optical-axis regions and a plurality of a fourth optical-axis regions, wherein the third optical-axis regions and the fourth optical-axis regions are alternatively arranged and adjacent to each other, and wherein directions of the third optical-axis regions are at −45 degree to direction of the second absorption axis and directions of the fourth optical-axis regions are at 45 degree to the direction of the second absorption axis;
wherein shapes, areas and arrangement of the first optical-axis regions and the second optical-axis regions on the first retarder and shapes, areas and arrangement of the third optical-axis regions and the fourth optical-axis regions on the second retarder are the same.

3. The dimming device according to claim 1, wherein the first polarizer and the second polarizer are selected from the group consisting of absorption-type polarizers, reflective polarizers, dyeing type polarizers, coatable polarizers, wire grid polarizers and a combination thereof.

4. The dimming device according to claim 1, wherein the first retarder and the second retarder are patterned retarders.

5. The dimming device according to claim 1, wherein retardation values of the first retarder and the second retarder are ±λ/4.

6. The dimming device according to claim 1, wherein the first retarder is attached on the first polarizer and the second retarder is attached on the second polarizer.

7. The dimming device according to claim 6, further comprising a first adhesive layer between the first retarder and the first polarizer for attaching the first retarder and the first polarizer, and a second adhesive layer between the second retarder and the second polarizer for attaching the second retarder and the second polarizer.

8. The dimming device according to claim 1, further comprising a horizontal moving device and a vertical moving device connecting to one of the first retarder and the second retarder for relatively moving the first retarder and the second retarder horizontally or vertically.

9. The dimming device according to claim 1, further comprising a horizontal moving device and a vertical moving device connecting respectively to both of the first retarder and the second retarder for relatively moving the first retarder and the second retarder horizontally or vertically.

10. The dimming device according to claim 6, further comprising a horizontal moving device and a vertical moving device connecting to one of the first polarizer and the second polarizer for relatively moving the first retarder and the second retarder horizontally and vertically.

11. The dimming device according to claim 6, further comprising a vertical moving device and a horizontal moving device connecting respectively to both of the first polarizer and the second polarizer for relatively moving the first retarder and the second retarder vertically and horizontally.

12. The dimming device according to claim 1, further comprising a functional layer on one side of the dimming device, wherein the functional layer is selected from the group consisting of a thermal insulation layer, an antilock layer, a hard coating layer, an antifouling layer, a brightness enhancement layer and a combination thereof.

13. The dimming device according to claim 2, wherein the first polarizer and the second polarizer are selected from the group consisting of absorption-type polarizers, reflective polarizers, dyeing type polarizers, coatable polarizers, wire grid polarizers and a combination thereof.

14. The dimming device according to claim 2, wherein the first retarder and the second retarder are patterned retarders.

15. The dimming device according to claim 2, wherein retardation values of the first retarder and the second retarder are ±λ/4.

16. The dimming device according to claim 2, wherein the first retarder is attached on the first polarizer and the second retarder is attached on the second polarizer.

17. The dimming device according to claim 16, further comprising a first adhesive layer between the first retarder and the first polarizer for attaching the first retarder and the first polarizer, and a second adhesive layer between the second retarder and the second polarizer for attaching the second retarder and the second polarizer.

18. The dimming device according to claim 2, further comprising a horizontal moving device and a vertical moving device connecting to one of the first retarder and the second retarder for relatively moving the first retarder and the second retarder horizontally or vertically.

19. The dimming device according to claim 2, further comprising a horizontal moving device and a vertical moving device connecting respectively to both of the first retarder and the second retarder for relatively moving the first retarder and the second retarder horizontally or vertically.

20. The dimming device according to claim 16, further comprising a horizontal moving device and a vertical moving device connecting to one of the first polarizer and the second polarizer for relatively moving the first retarder and the second retarder horizontally and vertically.

21. The dimming device according to claim 16, further comprising a vertical moving device and a horizontal moving device connecting respectively to both of the first polarizer and the second polarizer for relatively moving the first retarder and the second retarder vertically and horizontally.

22. The dimming device according to claim 2, further comprising a functional layer on one side of the dimming device, wherein the functional layer is selected from the group consisting of a thermal insulation layer, an antilock layer, a hard coating layer, an antifouling layer, a brightness enhancement layer and a combination thereof.
